(19) United States
(12) Patent Application Publication
(10) Pub. No.: US 2017/0168664 A1
(43) Pub. Date: Jun. 15, 2017

(54) REAL TIME DATA ANALYTICS AND VISUALIZATION

(71) Applicant: SAP SE, Walldorf (DE)

(72) Inventors: RAHUL KASHYAP, Delhi (IN); ARAVINDA PANTAR, Bangalore (IN); GURURAJ CS, Bangalore (IN); PRADEEP KUMAR, Azamgarh (IN)

(21) Appl. No.: 14/968,907

(22) Filed: Dec. 15, 2015

(51) Int. Cl. G06F 3/0482; H04L 12/26; G06T 11/20

(52) U.S. Cl. CPC G06F 3/0482; G06T 11/206; H04L 43/045; G06T 2200/24

(57) ABSTRACT

Various embodiments of systems and methods to provide real time data analytics and visualization are described herein. In one aspect, a list of microservices including transactional data are rendered on a graphical user interface. A request for analytics of the microservices is received. The request includes selection of a visualization type, at least one of the microservices, and corresponding at least one of an analytical dimension and a microservice dimension. Further, the microservices is analyzed based on the selection of the one of the microservices, and the corresponding at least one of the analytical dimension and the microservice dimension. Results of the analysis are displayed on the graphical user interface based on the selected visualization type.

### FIELD

Embodiments generally relate to computer systems and more particularly to methods and systems to provide real time data analytics and visualization.

### BACKGROUND

With the increasing deployment of cloud based services, web based applications, software as a service, service oriented architectures, and so forth, the locations of services and applications are crossing physical, jurisdictional, and security boundaries. Cloud platform provides a set of modular cloud based services with a set of development tools. One of the challenges with cloud platforms is providing analytics as a service (AaaS) and exposing a large volume of data to the AaaS provider in a secure way. AaaS refers to a provision of analytics software and operations through web-delivered technologies. Analytics tools in the cloud based services may depend on hardcore data model for analyzing data.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an example of a system in which an environment described herein may he implemented, according to an embodiment.

FIG. 2 is a flow diagram illustrating an example process to provide real time data analytics and visualization, according to an embodiment.

FIG. 3 is an exemplary graphical user interface (GUI) of a visualizer, according to an embodiment.

FIG. 4 is an exemplary graphical user interface (GUI) illustrating providing input for analytics, according to an embodiment.

FIG. 5 is an exemplary graphical user interface (GUI) illustrating results for an input provided in FIG. 4, according to an embodiment.

FIG. 6 is an exemplary graphical user interface (GUI) illustrating results for an input, according to an embodiment.

FIG. 7 is a block diagram of an example computing system, according to an embodiment.

### DETAILED DESCRIPTION

Embodiments of techniques to provide real time data analytics and visualization are described herein. In the below description, numerous specific details are set forth to provide a thorough understanding of embodiments. One skilled in the relevant art will recognize, however that the embodiments can be practiced without one or more of the specific details or with other methods, components, techniques, etc. In other instance, well-known operations or structures are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A situation where upon completion of the first step, a second step is executed will be specifically pointed out when not clear from the context. A particular step may be omitted. A particular step is required only when its omission would materially impact another step.

In this document, various computer-implemented methods, processes and procedures are described. It is to be understood that the various actions (determining, identifying, receiving, rendering, storing, retrieving, displaying etc.) are performed by a hardware device (e.g., computing system), even if the action may be authorized, initiated or triggered by a user, or even if the hardware device is controlled by a computer program, software, firmware, and the like. Further, it is to be understood that the hardware device is operating on data, even if the data may represent concepts or real-world objects, thus the explicit labeling as “data” as such is omitted.

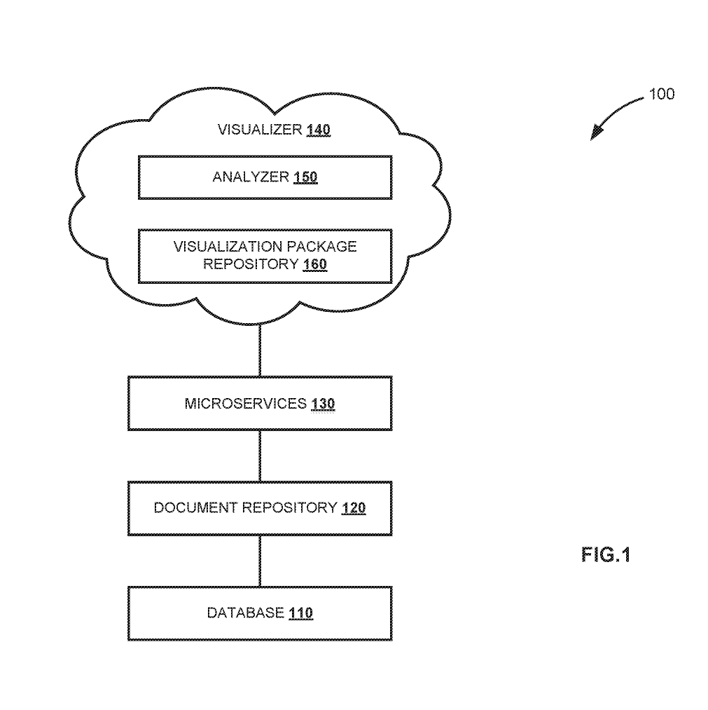

FIG. 1 is a block diagram illustrating an example of system 100 in which an environment described herein may be implemented, according to an embodiment. The system 100 illustrates a cloud platform, for example, hybris as a service® (YaaS®) platform provided by company SAP SE. The YaaS provides a programming model for services on microservice architecture. A microservice architecture could be based on RESTful microservices, for instance. Representational state transfer (REST) is an architectural style specifying constraints, such as a uniform interface, that if applied to a web service facilitates properties, such as performance, scalability, and modifiability. In the REST architectural style, data and functionality are considered as resources and are accessed using Uniform Resource Identifiers (URIs), such as links on the web and application programming interface (API) endpoints. Microservices can be a software architecture style in which applications are composed of small, independent processes and made to serve a purpose. For example, the microservices can be “customer” service, “product” service and the like.

The system 100 includes a database layer (e.g., database 110) to persist the transactional data corresponding to microservices such as “customers”, “orders”, “employees” and the like. The database 110 can be a cross-platform document oriented database including a set of collections. A collection holds a set of documents. The documents may have dynamic schema. Dynamic schema may refer to the documents in the same collection may not have the same set of fields or structure, and common fields in the documents may hold different types of data. An example of the database 110 is MongoDB®. MongoDB eschews the traditional table-based relational database structure in favor of JavaScript® Object Notation (JSON) like documents, making the integration of data in applications easier. Further, actions such as inserting, updating and deleting data on the database 110 is achieved via another layer, called a document repository layer (e.g., document repository 120) as the data in the database 110 is restricted to registered users. The document repository 120 is responsible for create, read, update and delete (CRUD) operations in the database 110. The document repository 120 provides a service to store or retrieve the data in form of multi tenancy. Thereby, the customers can have their own documents stored. For example, the document repository 120 is called to create microservice's own data persisted in the database 110.

The system 100 includes microservices 130. In the microservices 130, an option is provided to create a microservice, e.g., for a particular test. For example, joined data can be retrieved by creating another service, known as Mashup, which can get the data from different microservices and integrate as one response. Mashup uses content from more than one microservice to create a single new service displayed in a graphical user interface (GUI), e.g., on a user device.

In one embodiment, the system 100 includes visualizer 140 to generate real time reports using REST services built on the cloud platform. The visualizer 140 analyzes transactional data, during run time, associated with the microservices to generate analytical rich data using analyzer 150. Further, the analytical rich data is displayed on the GUI as a report. Further, the report can be persisted in a form of a visualization package (e.g., at visualization package repository 160). The visualization package can be used in other applications using the public shared uniform resource locator (URL) into an iframe tag, for instance. The iframe tag specifies an inline frame. The inline frame may be used to embed another document within a current hypertext markup language (HTML) document. In one exemplary embodiment, the visualizer 140 can be integrated into a platform layer itself and can be provided as Analytics as a Service (AaaS) to analyze large volume of data in real time. Further, the visualizer 140 displays the analyzed data on the GUI using different visualization types.

In one exemplary embodiment, a network allows user devices and the visualizer 140 to communicate and exchange data. The user device may be a computing device, such as a desktop computer, a laptop computer, a mainframe computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of two or more of such devices or other data processing devices, that is capable of accessing the visualizer 140. Thereby, an embedded analytics or analytics as a service in the cloud platform is achieved by the visualizer 140.

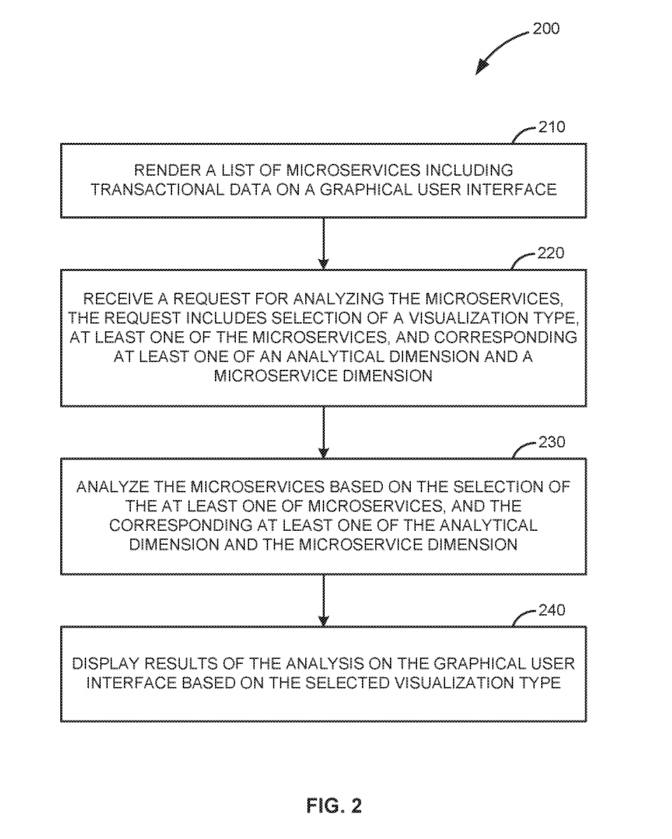

FIG. 2 is a flow diagram illustrating example process 200 to provide real time data analytics and visualization, according to an embodiment. The process 200 can be implemented for applications in cloud platform (e.g., YaaS platform), which enables ubiquitous network access to visualize analytical data. At 210, a list of microservices including transactional data is rendered on a graphical user interface (GUI). The microservices can be, but are not limited to “customer” service and “product” service. Further, the microservices may be retrieved using RESTful web services. For example, the YaaS platform uses RESTful webservices to expose the data to the users.

In one exemplary embodiment, the GUI includes different portions. One portion of the GUI renders the microservices to be analyzed. Example of microservices can be, but are not limited to “customers”, “products” and “orders.” Further, a microservice includes one or more microservice dimensions or attributes. For example, microservice “customers” includes microservice dimensions such as “customer names”, “customer ID”, “customer gender”, “customer age” and “customer status.”

At 220, a request is received for analyzing the microservices. The request includes selection of a visualization type and at least one of the microservices. The visualization type includes at least one of a histogram, a graph, a timeline, a chart, a popup, a list and a table. Further, the visualization type may include combination of different graphs or tables based on number of layouts on the GUI. Further, the request may include selection of at least one of an analytical dimension and a microservice dimension or a presentation dimension. The analytical dimension defines analytical parameter based on which the microservices are analyzed. The analytical dimension can be, but not limited to “count”, “group”, and “sum.” The microservice dimension defines attribute of the microservice such as “customer ID”, “customer status”, “customer gender” and the like. For example, a microservice “customer”, a microservice dimension “customer status” and an analytical dimension “count” is selected as input. In one exemplary embodiment, one portion of the GUI provides an option to input the request.

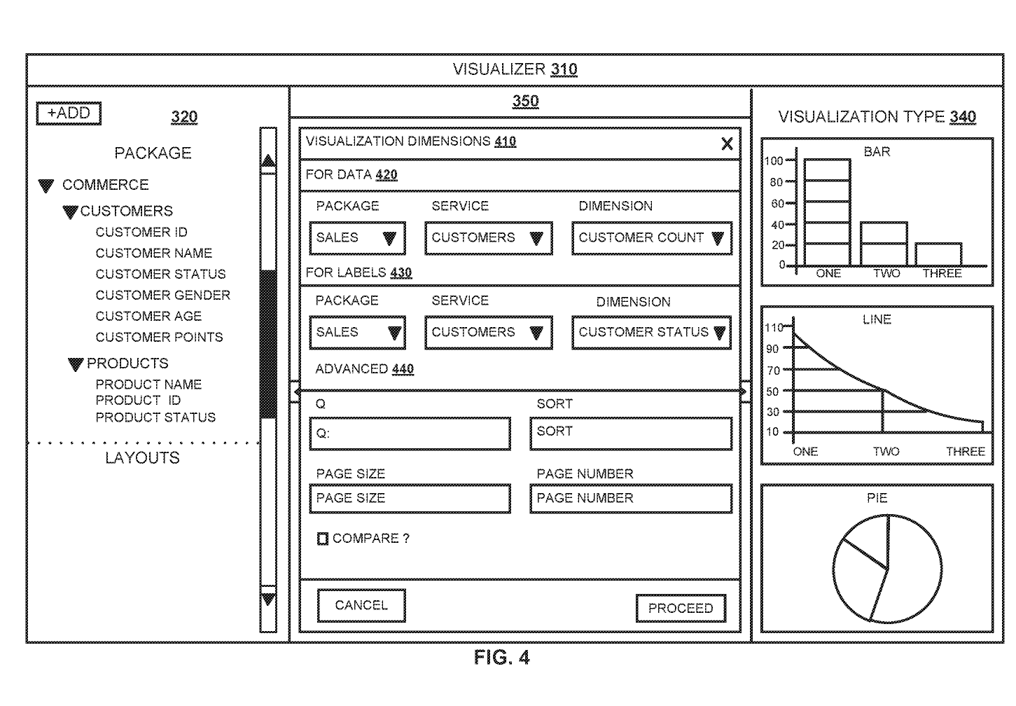

At 230, the microservices are analyzed based on the selection of the at least one of the microservices, and the corresponding at least one of the analytical dimension and the microservice dimension. In the example, the count (e.g., analytical dimension) of number of customers (e.g., microservice) having “inactive” status and “active” status (e.g., microservice dimension) are determined based on the request. At 240, the results of the analysis are displayed on the GUI based on the selected visualization type. For example, when the histogram is selected as the visualization type, the count of number of “active” customers and the count of number of “inactive” customers are displayed on a bar chart. In one exemplary embodiment, the visualizer enables advanced operations such as, but not limited to drill down, comparison of results of a query and an order in which the results are sorted, which are illustrated in FIG. 4.

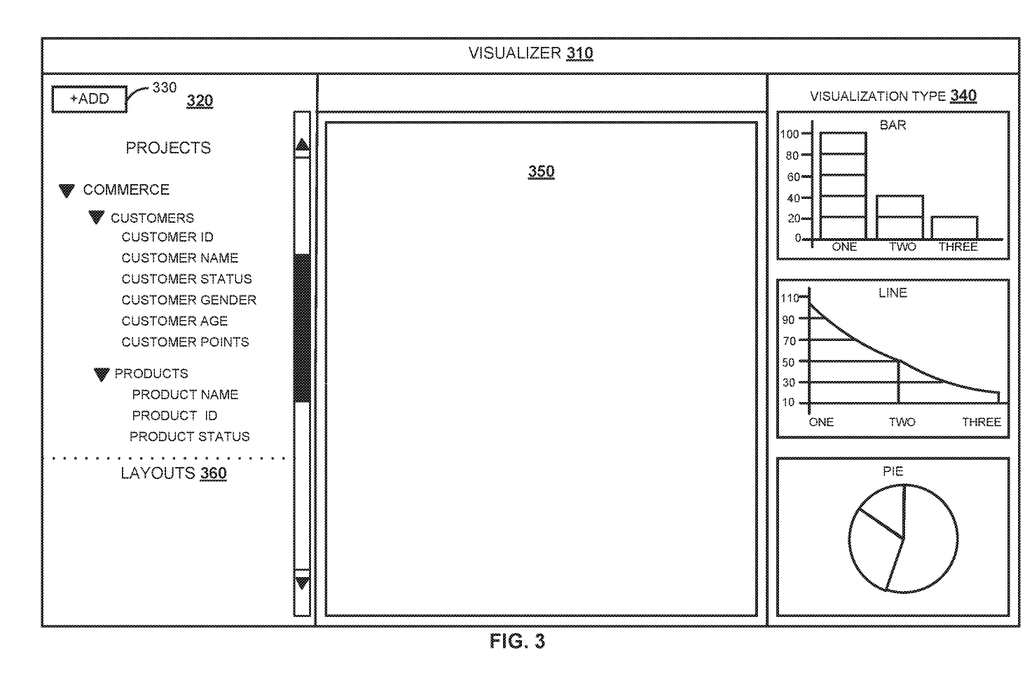

FIG. 3 is an exemplary graphical user interface (GUI) of visualizer 310, according to an embodiment. The GUI of visualizer 310 includes multiple portions (e.g., 320, 340 and 350). First portion (e.g., 320) renders a list of microservices which are extracted from a database using RESTful microservice. Further, the microservices can be indexed under different packages. Further, an option (e.g., add 330) enables to add microservices. For example, the package “commerce” includes microservices such as “customers” and “products” as shown in portion 320 of FIG. 3.

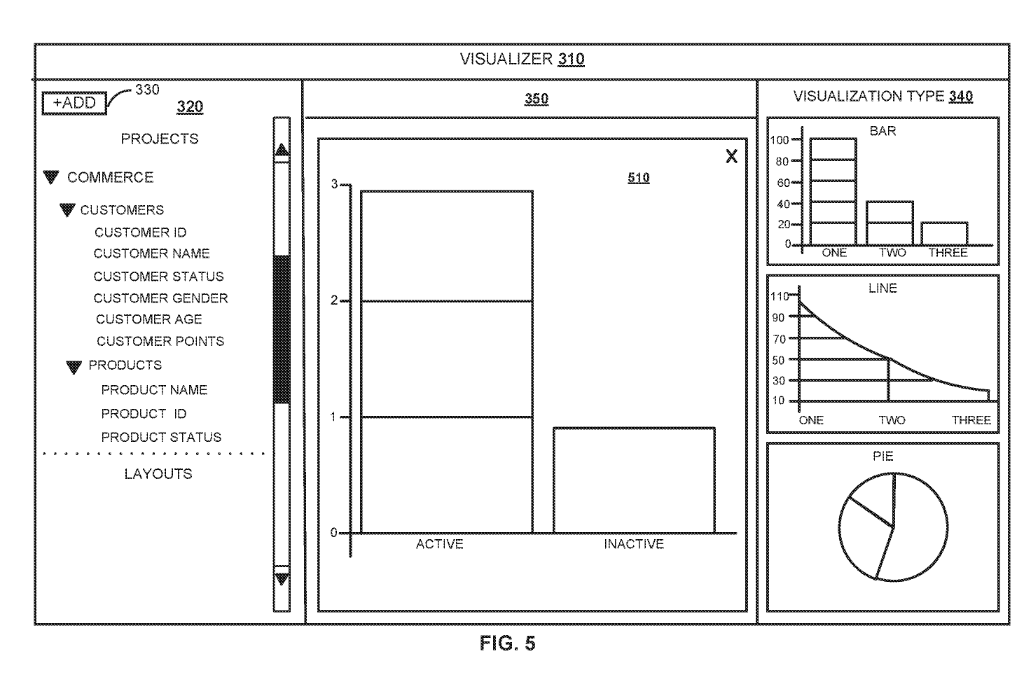

Second portion (e.g., 340) provides a list of visualization types such as, but not limited to a histogram, a line graph, a pie chart. In one exemplary embodiment, a user can select a type of graph on which analyzed data can be visualized by performing actions such as, but are not limited to dragging and dropping desired chart, double clicking the chart. Another portion on the GUI provides an option (e.g., layouts 360) to display the analytics in multiple layouts. For example, when a user desire to visualize multiple charts, the user can select multiple layouts to be displayed on the GUI. Further, third portion (e.g., 350) provides an option to receive request for analytics and display results of the analysis based on the received request, which are illustrated in FIGS. 4 and 5.

FIG. 4 is an exemplary graphical user interface (GUI) illustrating providing input for analytics, according to an embodiment. FIG. 4 illustrates the portion 350 of FIG. 3. In one exemplary embodiment, the portion 350 includes a pop-up, which enables a user to provide input for analyzing microservices rendered in the portion 320. In one exemplary embodiment, the pop-up provides an option to input visualization dimensions 410. The visualization dimensions 410 include details of data plotted in different axis of a graph depending on visualization type 340 as selected by the user. For example, when a histogram is selected as the visualization type 340, “for data” 420 and “for labels” 430 are displayed. “For data” 420 depicts data to be plotted in Y axis and the “for labels” 430 depicts data to be plotted in X axis. Further, the visualization dimensions may include selection of details such as, but are not limited to, package (e.g., “commerce”) in which the microservices are associated, particular microservices (e.g., “customers” and “products”), an analytical dimension (e.g., “customer count”), and a microservice dimension (e.g., “customer status”). Thereby, the input includes selection of the visualization type, at least one of the microservices, and corresponding at least one the analytical dimension and the microservice dimension.

Further, the pop-up may include optional features (e.g., 440) such as, but limited to, comparing results of a query and sorting the results based on the comparison. For example, the features include an option to provide query (e.g., “q: customer ID”), sort in an order (e.g., ascending order, descending order), number of results to be displayed in a page (e.g., page size) and page numbers.

FIG. 5 is an exemplary graphical user interface (GUI) illustrating results for the input provided in FIG. 4, according to an embodiment. The portion 350 displays analysis of microservices based on the input provided in FIG. 4. For example, the portion 350 displays a graph (e.g., 510) depicting a count of number of “active” customers and a count of number of “inactive” customers.

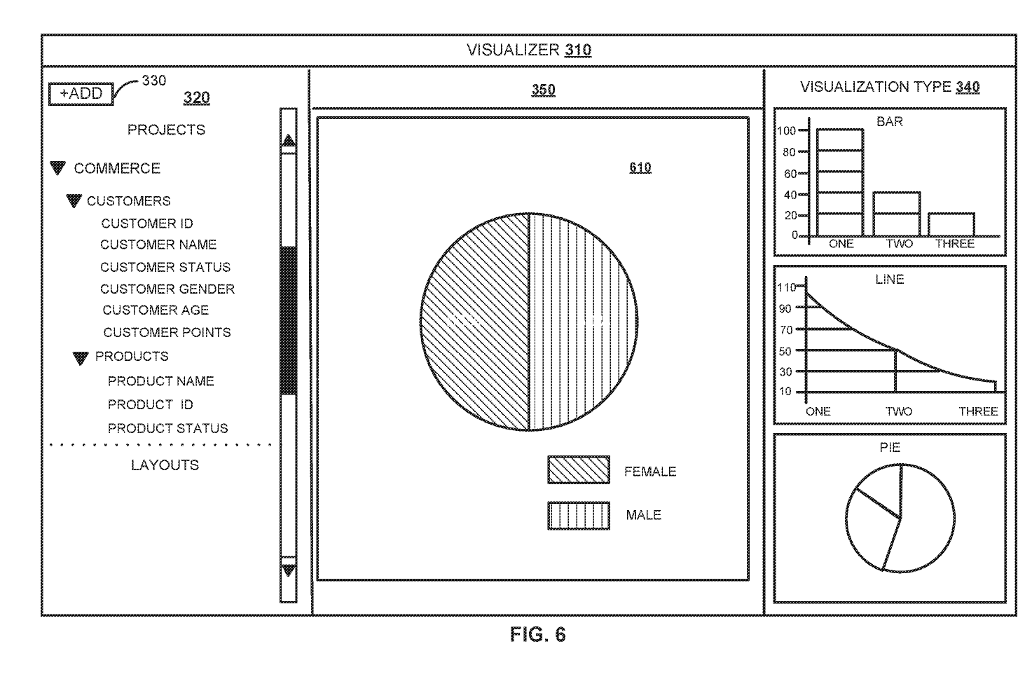

FIG. 6 is an exemplary graphical user interface (GUI) illustrating results for an input, according to an embodiment. Consider example with data depicted in Table 1.

TABLE 1

| Customer ID | Name | Gender | Age |
|---|---|---|---|
| 1234 | ABC | Male | 25 |
| 5678 | DEF | Female | 23 |
| 3456 | GHI | Female | 28 |
| 8525 | XYZ | Male | 27 |

When a user desire to analyze the data in Table 1 by grouping customer based on gender, an input including a visualization type (e.g., pie chart), microservices (e.g., customers), corresponding analytical dimension (e.g., group) and microservice dimension (e.g., customer gender) is provided to a visualizer. Based on the input, a graph (e.g., 610) is displayed on the GUI depicting grouping of customers as per genders. Thereby, the portion 350 of the visualizer 310 displays analysis of microservices based on the input including visualization type as pie chart and grouping based on the gender of the customers.

The process described above is not limited to embodiments that solve any disadvantages or that operate only in environments such as those described above. Further, the above described process to model the data internally and provide analytical capability and configured to visualize the analysis.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computing system that is remotely located from a second computing system containing an interface level (e.g., a graphical user interface). These first and second computing systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computing system which causes the computing system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

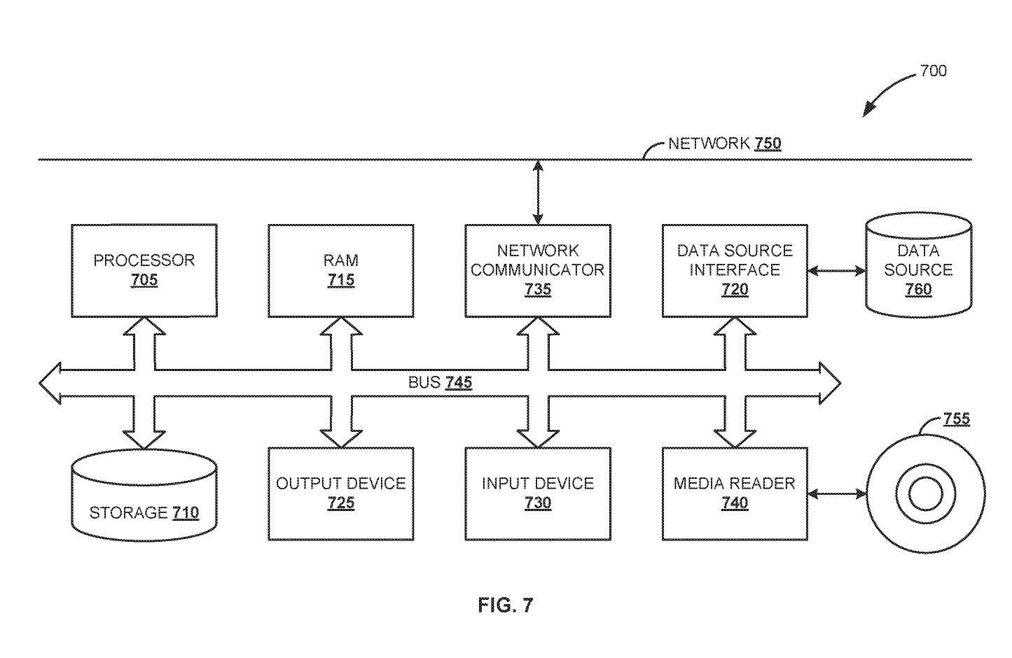

FIG. 7 is a block diagram of example computing system 700, according to an embodiment. The computing system 700 includes a processor 705 that executes software instructions or code stored on a computer readable storage medium 755 to perform the above-illustrated methods. The processor 705 can include a plurality of cores. The computing system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computing system 700 further includes an output device 725 (e.g., a display) to provide at least some of the results of the execution as output including, but not limited to, visual information to users and an input device 730 to provide a user or another device with means for entering data and/or otherwise interact with the computing system 700. One or more of these output devices 725 and input devices 730 could be joined by one or more additional peripherals to further expand the capabilities of the computing system 700. A network communicator 735 may be provided to connect the computing system 700 to a network 750 and in turn to other devices connected to the network 750 including other clients, servers, data stores, and interfaces, for instance. The modules of the computing system 700 are interconnected via a bus 745. Computing system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as. Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to provide real time data analytics and visualization comprising:
rendering a list of a plurality of microservices including transactional data on a graphical user interface;
receiving a request for analytics of the plurality of microservices, wherein the request comprises selection of a visualization type, at least one of the plurality of microservices, and corresponding at least one of an analytical dimension and a microservice dimension:
analyzing the plurality of microservices based on the selection of the one of the plurality of microservices, and the corresponding at least one of the analytical dimension and the microservice dimension; and
displaying results of the analysis on the graphical user interface based on the selected visualization type.

2. The computer implemented method of claim 1, wherein the plurality of microservices is rendered using RESTful web services.

3. The computer implemented method of claim 1, wherein the visualization type comprises at least one of a histogram, a graph, a timeline, a chart, a popup, a list, and a table.

4. The computer implemented method of claim 1, wherein the request further comprises an input to compare results of a query.

5. The computer implemented method of claim 4, wherein the request further comprises an input to sort the results in an order based on the comparison.

6. The computer implemented method of claim 1, wherein the analytical dimension defines analytical parameter based on which the plurality of microservices are analyzed.

7. The computer implemented method of claim 1, wherein the graphical user interface provides an option to display the results of the analysis in multiple layouts.

8. A computing system to provide real time data analytics and visualization comprising:
at least one processor; and
one or more memory devices communicative with the at least one processor, wherein the one or more memory devices store instructions to:
render a list of a plurality of microservices including transactional data on a graphical user interface;
receive a request for analytics of the plurality of microservices, wherein the request comprises selection of a visualization type, at least one of the plurality of microservices, and corresponding at least one of an analytical dimension and a microservice dimension;
analyze the plurality of microservices based on the selection of the one of the plurality of microservices, and the corresponding at least one of the analytical dimension and the microservice dimension; and
display results of the analysis on the graphical user interface based on the selected visualization type.

9. The computing system of claim 8, wherein the plurality of microservices is rendered using RESTful web services.

10. The computing system of claim 8, wherein the visualization type comprises at least one of a histogram, a graph, a timeline, a chart, a popup, a list, and a table.

11. The computing system of claim 8, wherein the request further comprises an input to compare results of a query.

12. The computing system of claim 11, wherein the request further comprises an input to sort the results in an order based on the comparison.

13. The computing system of claim 8, wherein the analytical dimension defines analytical parameter based on which the plurality of microservices are analyzed.

14. The computing system of claim 8, wherein the graphical user interface provides an option to display the results of the analysis in multiple layouts.

15. A graphical user interface (GUI) displayable on a computing device, comprising:
a first portion to render a list of a plurality of microservices;
a second portion listing visualization types; and
a third portion to receive request for analytics and display results of the analysis based on the received request.

16. The graphical user interface of claim 15, wherein the graphical user interface provides an option to display the results of the analysis in multiple layouts.

17. The graphical user interface of claim 15, wherein the visualization types comprise at least one of a histogram, a graph, a timeline, a chart, a popup, a list, and a table.

18. The graphical user interface of claim 15, wherein the request comprises selection of a visualization type, at least one of the plurality of microservices, and corresponding at least one of an analytical dimension and a microservice dimension.

19. The graphical user interface of claim 18, wherein the request further comprises an input to compare results of a query and an input to sort the results in an order.

20. The graphical user interface of claim 18, wherein the analytical dimension defines analytical parameter based on which the plurality of microservices are analyzed.
